(19) United States
(12) Patent Application Publication
(10) Pub. No.: US 2019/0345754 A1
(43) Pub. Date: Nov. 14, 2019

(54) VACUUM INSULATING GLASS (VIG) WINDOW UNIT

(71) Applicant: Guardian Glass, LLC, Auburn Hills, MI (US)

(72) Inventors: Timothy M. SINGEL, Novi, MI (US); Jason THEIOS, Toledo, OH (US)

(21) Appl. No.: 15/974,732

(22) Filed: May 9, 2018

(51) Int. Cl. E06B 3/67; C03C 17/36; C03C 17/34; E06B 3/66; E06B 9/24

(52) U.S. Cl. CPC E06B 3/6715; C03C 17/3626; C03C 17/3644; C03C 17/366; C03C 17/3681; E06B 2009/2417; E06B 3/6612; E06B 9/24; C03C 2217/948; C03C 2217/944; C03C 17/3435

(57) ABSTRACT

In certain example embodiments of this invention, a window unit may include a vacuum IG (VIG) unit as an inboard lite and a monolithic lite as an outboard lite. A dead air space may separate the inboard and outboard lites. Low-emissivity (low-E) coatings are provided in particular locations of the window unit in order to reduce the likelihood of thermal breakage by reducing the temperature of at least one of the glass substrates. For example, in certain example embodiments, low-E coatings are provided in particular locations of the window unit in order to reduce the temperature of a middle glass substrate of the structure, which in turn reduces the difference in temperature between the two glass substrates of the VIG unit, thereby reducing the likelihood of thermal breakage of the window.

This application relates to a window unit. In certain example embodiments, the window unit includes a vacuum insulating glass (VIG) unit and at least one additional glass substrate, and thus may be referred to as a hybrid window unit. Low-emissivity (low-E) coatings are provided in particular locations of the window unit in order to reduce the likelihood of thermal breakage by reducing the temperature of at least one of the glass substrates. For example, in certain example embodiments, low-E coatings are provided in particular locations of the window unit in order to reduce the temperature of a middle glass substrate of the structure such as in warm ambient conditions (e.g., summer months, or warm environments), which in turn reduces the difference in temperature between the two glass substrates of the VIG unit, thereby reducing the likelihood of thermal breakage of the window. Windows according to various embodiments of this invention may be used for residential or commercial building or door windows, refrigerator or freezer windows, skylights, and/or other suitable applications. Windows according to various embodiments of this invention may be used in either vertical or sloped orientations (e.g., vertical orientation when in the exterior wall of a building or home, or in a refrigerator/freezer door in a store).

### BACKGROUND AND SUMMARY OF THE INVENTION

Hybrid windows are known in the art. For example, U.S. Pat. No. 8,900,679, the disclosure of which is hereby incorporated herein by reference in its entirety, discloses a hybrid window including both a vacuum insulating glass (VIG) window unit as an inboard lite and a monolithic lite as an outboard lite. A dead air space may separate the inboard and outboard lites.

Prior art FIGS. 1 and 2 illustrate a hybrid window from the '679 patent, where the hybrid window includes surface #s 1-6. FIG. 1 illustrates that the window unit includes a vacuum IG (VIG) unit 1 as an inboard lite and a monolithic lite 3 as an outboard lite. A dead air space 5 separates the inboard and outboard lites. Space 5 may be at atmospheric pressure in certain example embodiments, although it may instead be filled with gas and/or at a pressure lower than atmospheric in different example embodiments. The vacuum IG unit 1, which is the inboard lite in FIG. 1, includes an inner glass substrate 7 and an outer glass substrate 9. Edges of opposing vacuum IG glass substrates 7 and 9 are hermetically sealed by at least one edge or peripheral seal 4. “Peripheral” and “edge” seals herein do not mean that the seal(s) are located at the absolute periphery or edge of the unit, but instead mean that the seal is at least partially located at or near (e.g., within about two inches of) an edge of at least one substrate of the VIG unit. The vacuum IG unit may include first and second opposing glass substrates 7 and 9 which are spaced from one another by spacers/pillars 24 which maintain low pressure space 26 between the substrates. The space 26 is at a pressure less than atmospheric pressure. Substrates 7 and 9 may be of soda-lime-silica based float glass. Hermetic peripheral or edge seal 4, provided between the substrates 7 and 9, seals off low pressure space 26 from surrounding atmospheric pressure. The peripheral/edge seal 4 may be located entirely between the opposing substrates, as shown in FIG. 1. However, the peripheral/edge seal 4 may instead be located partially between substrates 7 and 9, and partially in an L-shaped step area (not shown) at the periphery of the unit in non-illustrated instances where the glass sheets 7 and 9 are of different sizes. The evacuation of space 26 eliminates or reduces heat transport between glass substrates 7 and 9 due to gaseous conduction and convection. Low gaseous thermal conduction may be achieved when the pressure in space 26 is reduced to a level e.g., equal to or below about 0.5×10⁻³ Torr, more preferably below about 0.1 mTorr, or 10⁻⁴ Torr, and most preferably below about 10⁻⁶ Torr of atmospheric pressure. The hermetic sealing system 4, including one or more edge seals, substantially eliminates any ingress or outgress of gas or air to/from low pressure space 26. An array of spacers or pillars 24 is provided between substrates 7 and 9 in order to maintain separation of the two approximately parallel glass sheets 7, 9 against atmospheric pressure. All spacers 24 may be approximately the same size and/or material. However, in other embodiments, there may be different sizes of spacers 24 in the same vacuum IG unit.

A highly insulated foam core insulating frame 30 may be used to support the inner and outer lites 1, 3. In certain example embodiments, the foam functions as insulating so as to provide an insulating function and structure for supporting the lites 1, 3, although material(s) other than foam may be used for frame 30. The insulating frame 30 may be a window sash in certain example embodiments of this invention, and may have a polymer based cover (e.g., vinyl) surrounding a foam core in certain example instances. The VIG unit 1, as well as monolithic outboard lite 3 (which may be made up of a glass substrate) may both be supported by the frame.

The VIG lite 1 may be located on the inboard side in certain example embodiments, so as to avoid temperature swings on the inner side of the window unit and to protect the VIG unit from potential damage from the exterior of the building on which the window unit is located. Bite “B” distance may be designed between the bottom edge of the VIG unit and the upper edge of the bottom frame portion to help make it more difficult for heat and/or cold to makes its way around the edge of the VIG unit 1 thru the possible solder edge seal 4. In FIG. 1, the outer monolithic glass lite 3 may be glued to the sash/frame 30 via adhesive at area 40 which may also function as a seal. There may be a bottom stop 44 upon which outboard lite 3 rests in L-shaped channel 46. Another channel 48 may be provided in the sash or frame 30, for helping support the VIG unit, with a horizontal portion of the channel possibly permitting a stop 50 to be inserted and/or removed in the frame. Glue may also be put in the channel 48 to hold the VIG lite 1 in place. The VIG lite 1 may be held in place via glue at areas 50a in certain example instances.

FIG. 2 illustrates the window unit of FIG. 1, including the VIG unit 1 including glass substrates 7, 9 and spacers 24, and the outboard lite 3, in another type of frame where a phase change material (PCM) may be provided interior of the inner glass sheet of the IG unit. It is possible for the bottom (and possibly the top and both sides) of the VIG unit (and/or the monolithic lite 3) to be mounted in at least one structurally insulated panel (SIP) which may include oriented strand board (OSB) sheets 60 that are aligned approximately parallel to the glass sheets 7, 9 of the VIG unit, and insulation such as foam insulation 62 located between the OSB sheets 60 and the VIG unit. Trim 66 may be used to aesthetic purposes.

The frames of FIGS. 1 and 2 are provided for purposes of example only, and are without limitation, in order to place a hybrid window unit in example context.

While hybrid window units such as those shown in FIGS. 1-2 provide good insulating features, there is room for improvement. For instance, hybrid window units have been susceptible to thermal induced breakage. Certain example embodiments of this invention provide for a hybrid window design which reduces the likelihood of thermal breakage.

In certain example embodiments of this invention, the window unit includes a vacuum insulating glass (VIG) unit and at least one additional glass substrate, and thus may be referred to as a hybrid window unit. Low-emissivity (low-E) coatings are provided in particular locations of the window unit in order to reduce the likelihood of thermal breakage by reducing the temperature of at least one of the glass substrates. For example, in certain example embodiments, low-E coatings are provided in particular locations of the window unit in order to reduce the temperature of a middle glass substrate of the structure, which in turn reduces the difference in temperature between the two glass substrates of the VIG unit, thereby reducing the likelihood of thermal breakage of the window.

In certain example embodiments, it has surprisingly and unexpectedly been found that providing low-E coatings on surface #2, surface #5, and surface #6 (but not on surface #s 1, 3 and 4) of the hybrid window unit advantageously reduces the temperature of the middle glass substrate of the structure such as in warm ambient conditions (e.g., summer months, or warm environments), which in turn reduces the difference in temperature between the two glass substrates of the VIG unit, thereby reducing the likelihood of thermal breakage of the window.

Windows according to various embodiments of this invention may be used for residential or commercial building or door windows, refrigerator or freezer windows, skylights, and/or other suitable applications. Windows according to various embodiments of this invention may be used in either vertical or sloped orientations (e.g., vertical orientation when in the exterior wall of a building or home, or in a refrigerator/freezer door in a store).

In an example embodiment of this invention, there is provided a window unit comprising: a first glass substrate configured to be located at an exterior side of the window unit to face a building exterior; a vacuum insulating glass (IG) window unit comprising second and third glass substrates spaced apart from each other via at least a plurality of spacers, and having a low pressure space between the second and third glass substrates at pressure less than atmospheric pressure, wherein the third glass substrate is configured to be located at an interior side of the window unit to face a building interior, and the second glass substrate is a middle glass substrate located between at least the first and third glass substrates; an air gap provided between the first glass substrate and the second glass substrate; a first low emissivity (low-E) coating comprising at least one infrared (IR) reflecting layer located between at least a pair of dielectric layers, wherein the first low-E coating is located on a major surface of the first glass substrate facing the air gap; a second low-E coating comprising at least one IR reflecting layer located between at least a pair of dielectric layers, wherein the second low-E coating is located on a first major surface of the third glass substrate facing the low pressure space; a third low-E coating comprising at least one IR reflecting layer located between at least a pair of dielectric layers, wherein the third low-E coating is located on a second major surface of the third glass substrate and is configured to face a building interior, so that the third glass substrate is located between the second and third low-E coatings; and wherein no low-E coating is provided on the second glass substrate.

### BRIEF DESCRIPTION OF THE DRAWINGS

FIG. 1 is a cross sectional view of a conventional hybrid window unit.

FIG. 2 is a cross sectional view of a conventional hybrid window unit.

FIG. 3 is a cross sectional view of a hybrid window unit according to an example embodiment of this invention, which may be used in connection with FIGS. 1-2.

FIG. 4 is a cross sectional view of portions of a hybrid window unit according to an example embodiment of this invention, which may be used in connection with any of FIGS. 1-3.

FIG. 5 is a table including data from various window units.

### DETAILED DESCRIPTION OF EXAMPLE EMBODIMENTS OF THE INVENTION

In certain example embodiments of this invention, the window unit includes a vacuum insulating glass (VIG) unit 1 and at least one additional glass substrate 3, and thus may be referred to as a hybrid window unit. For purposes of example only, and without limitation, example VIG units which may be used for VIG unit 1 are illustrated and/or described in U.S. Pat. Nos. 6,372,312, 6,365,242, 6,399,169, 6,336,984, 6,497,931, and/or 6,692,600, the disclosures of which are all hereby incorporated herein by reference. Low-emissivity (low-E) coatings 100, 200 and 300 are provided in particular locations of the window unit in order to reduce the likelihood of thermal breakage by reducing the temperature of at least one of the glass substrates. For example, in certain example embodiments, low-E coatings 100, 200, and 300 are provided in particular locations of the window unit in order to reduce the temperature of a middle glass substrate 9 of the structure, which in turn reduces the difference in temperature between the two glass substrates 7 and 9 of the VIG unit, thereby reducing the likelihood of thermal breakage of the window including the VIG unit. While reducing the temperature of the middle lite is important, so too is increasing the temperature of the inboard lite to achieve the overall example objective of reducing the temperature differential across the VIG. Thermal breakage occurs in heating and cooling dominated climates, during warm sunny days and cold winter nights for instance. Example embodiments of this invention reduce the risk of thermal breakage under such conditions.

In certain example embodiments, it has surprisingly and unexpectedly been found that providing low-E coatings 100, 200 and 300 on surface #2, surface #5, and surface #6, respectively (but optionally not on surface #s 1, 3 and/or 4) of the hybrid window unit advantageously reduces the temperature of the middle glass substrate 9 of the structure such as in warm ambient conditions (e.g., summer months, or warm environments), which in turn reduces the difference in temperature between the two glass substrates 7 and 9 of the VIG unit 1, thereby reducing the likelihood of thermal breakage of the window. Example low-E coatings, which may be used for example and without limitation for any of low-E coatings 100, 200 and/or 300 are described in U.S. Pat. Nos. 9,863,182, 9,199,875, 9,902,238, 9,776,915, 9,873,633, 9,816,316, 9,796,620, 6,936,347, 5,688,585, 5,557,462, 5,425,861, 4,413,877 and 3,682,528, the disclosures of which are all hereby incorporated herein by reference.

Windows according to various embodiments of this invention may be used for residential or commercial building or door windows, refrigerator or freezer windows, skylights, and/or other suitable applications. Windows according to various embodiments of this invention may be used in either vertical or sloped orientations (e.g., vertical orientation when in the exterior wall of a building or home, or in a refrigerator/freezer door in a store).

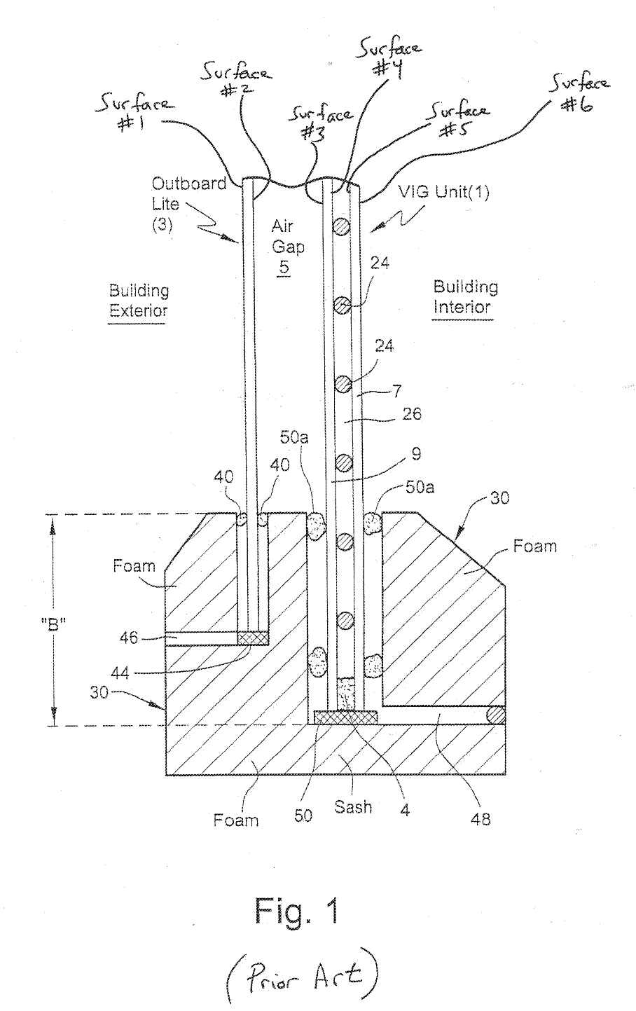

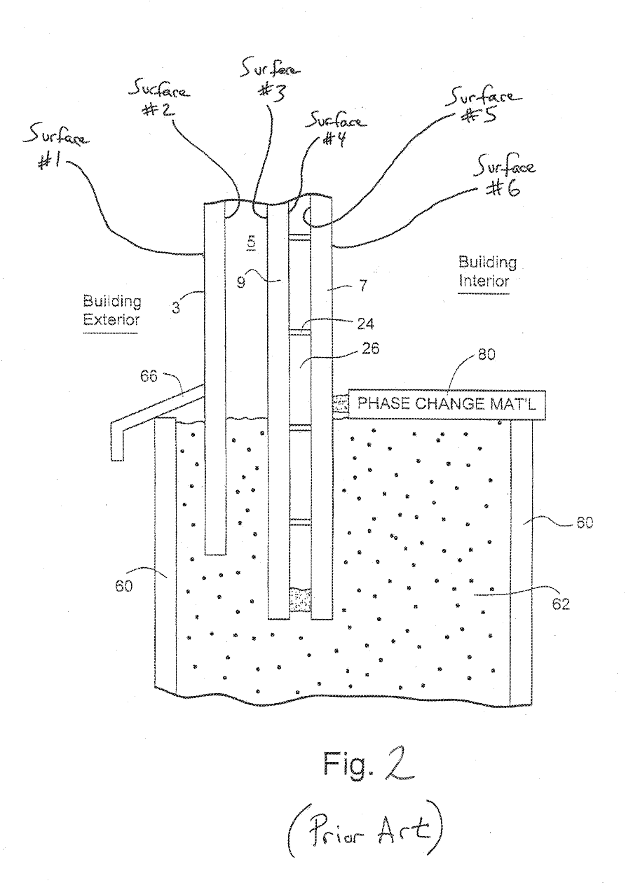

FIGS. 1-2 illustrate example hybrid window units, including both a vacuum insulating glass (VIG) window unit 1 as an inboard lite and a monolithic lite 3 as an outboard lite. Air gap 5 separates the inboard and outboard lites, and low pressure space 26 is provided between the glass substrates 7 and 9 of the VIG unit. FIGS. 1-2 illustrate that the hybrid window includes surface #s 1-6, with the surfaces being major surfaces of glass substrates numbered in order beginning at what is to be the exterior of the building and proceeding toward what is to be an interior of the building on which the window is, or is to be, mounted.

Conventionally, thermal and solar performance were maximized in such hybrid windows when the VIG unit 1 is used as the inboard lite and low-E coatings were provided on surface #2 and also on surface #4 or #5.

Unfortunately, while placing low-E coatings on surface #s 2 and 4 achieves good solar characteristics, it has been found that such a design leads to excessive heat build-up of the middle glass substrate 9, especially in warm ambient conditions such as summer type ambient temperatures. This heat build-up of middle glass substrate 9 has been found to significantly increase the likelihood of thermally-induced breakage and temperature differential-induced deflection of the VIG unit 1.

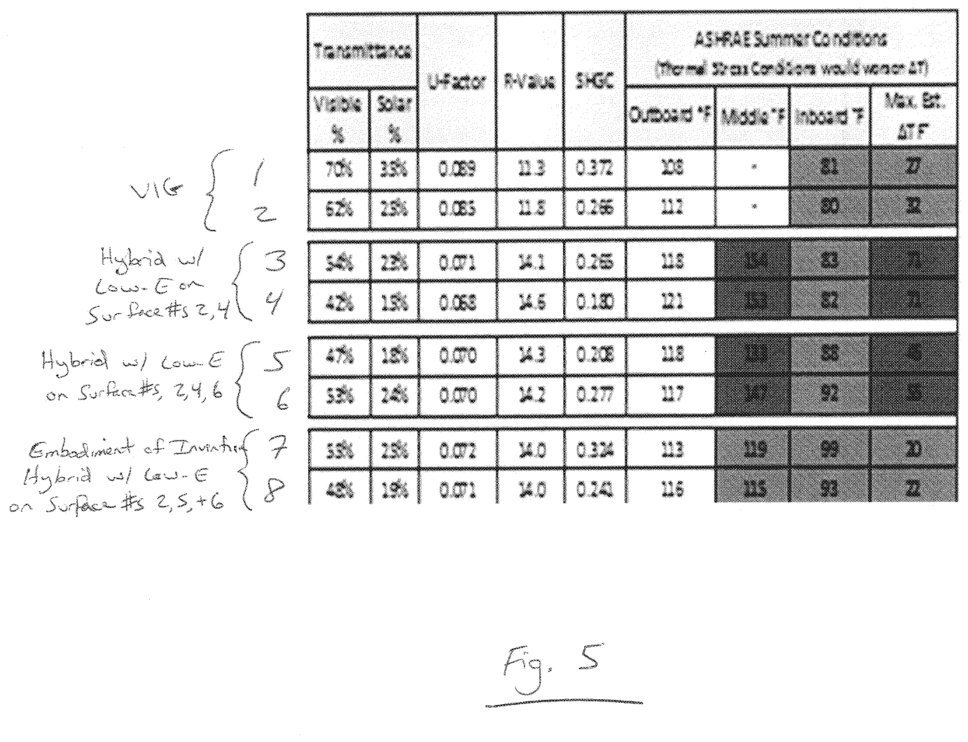

FIG. 5 is a chart listing eight different window units, samples numbered 1-8. Sample Nos. 1-2 in FIG. 5 are conventional VIG units with a low-E coating on surface #2. Sample Nos. 3-4 in FIG. 5 are hybrid window units such as those shown in FIGS. 1-2, with low-E coatings provided on surface #2 and surface #4. And Sample Nos. 5-6 in FIG. 5 are hybrid window units such as those shown in FIGS. 1-2, with low-E coatings provided on surface #2, surface #4, and surface #6.

Still referring to FIG. 5, it can be seen that for sample No. 3 the outboard glass substrate 3 was at 118 degrees F., the middle glass substrate 9 was at 154 degrees F., and the innermost glass substrate 7 was at 83 degrees F. Thus, the maximum difference in temperature between glass substrates for Sample No. 3 was 71 degrees (154−83=71). It can be seen that for sample No. 4 the outboard glass substrate 3 was at 121 degrees F., the middle glass substrate 9 was at 153 degrees F., and the innermost glass substrate 7 was at 82 degrees F. Thus, the maximum difference in temperature between glass substrates for Sample No. 4 was 71 degrees (153−82=71). It can be seen that for sample No. 5 the outboard glass substrate 3 was at 118 degrees F., the middle glass substrate 9 was at 133 degrees F., and the innermost glass substrate 7 was at 88 degrees F. Thus, the maximum difference in temperature between glass substrates for Sample No. 5 was 45 degrees (133−88=45). And it can be seen that for sample No. 6 the outboard glass substrate 3 was at 117 degrees F., the middle glass substrate 9 was at 147 degrees F., and the innermost glass substrate 7 was at 92 degrees F. Thus, the maximum difference in temperature between glass substrates for Sample No. 6 was 55 degrees (147−92=55).

These temperatures over 130 degrees for the middle glass substrate 9, and the temperature differences between VIG glass substrates of at least 43 degrees, for Sample #s 3-6 are problematic as explained above. In other words, placing low-E coatings on surface #s 2 and 4 (Sample Nos. 3-4) has been found to lead to excessive heat build-up of the middle glass substrate 9, especially in warm ambient conditions such as summer type ambient temperatures. And placing low-E coatings on surface #s 2, 4, and 6 (Sample Nos. 5-6) has also been found to lead to excessive heat build-up of the middle glass substrate 9, especially in warm ambient conditions such as summer type ambient temperatures. These heat build-ups of middle glass substrate 9 have been found to significantly increase the likelihood of thermally-induced breakage and temperature differential-induced deflection of the VIG unit 1. Moreover, it is noted that Samples 1-2, of a VIG along without an additional glass substrate 3, have undesirably low R-Values, and are problematic for at least this reason.

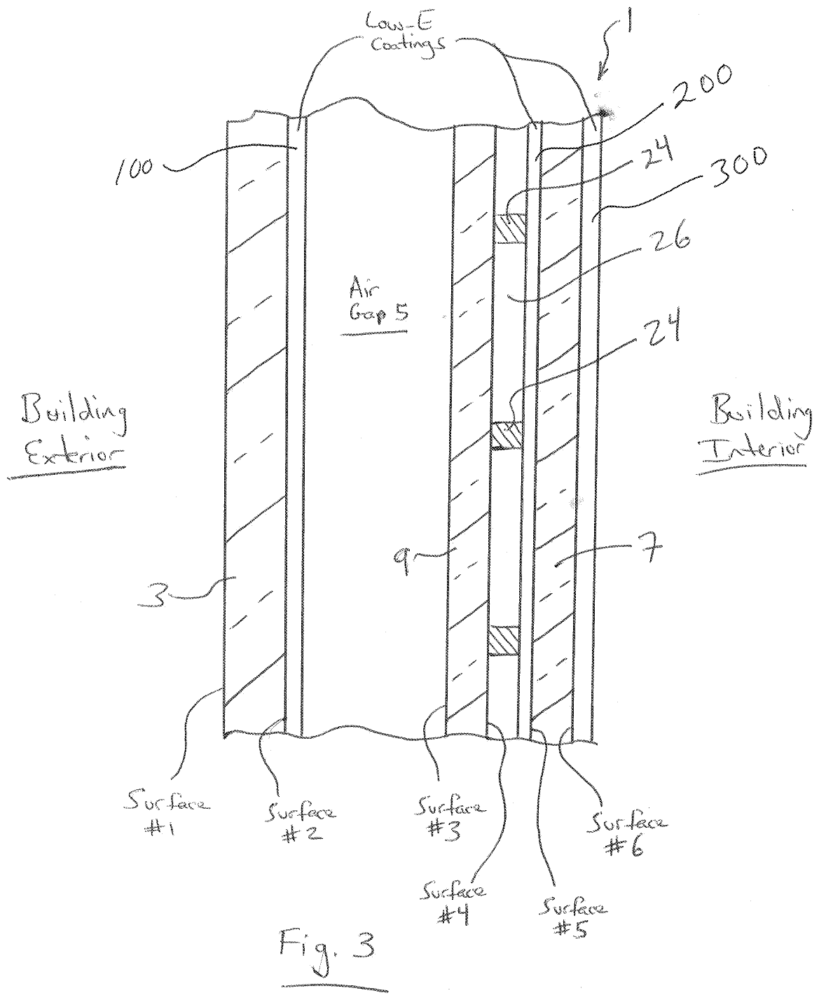

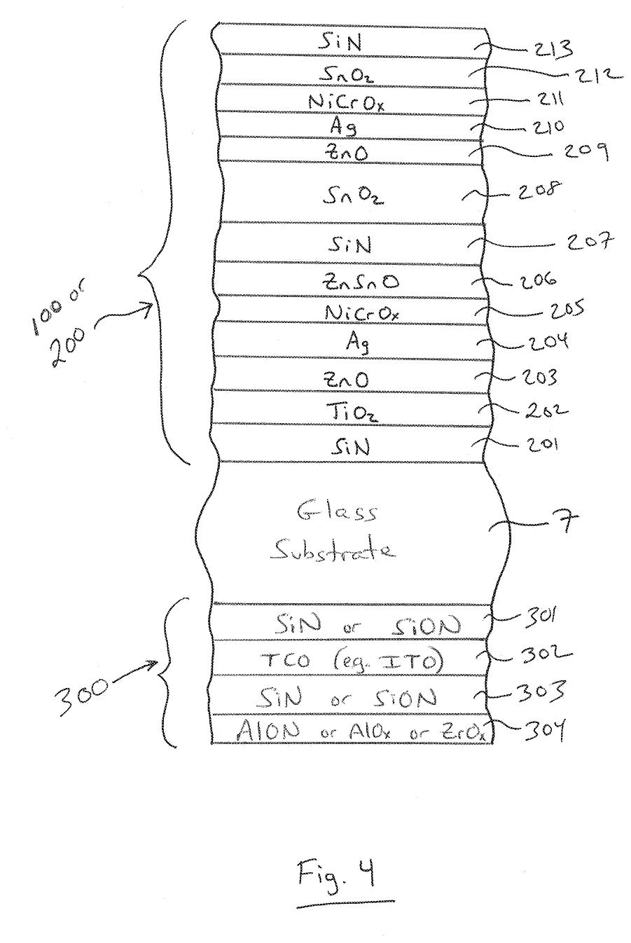

The above problems are addressed and solved by example embodiments of this invention, reflected by Sample Nos. 7-8 in FIG. 5 and by the structures illustrated in FIGS. 3-4. In Sample Nos. 7-8 shown in FIG. 5, according to example embodiments of this invention reflected in FIGS. 3-4, low-E coatings 100, 200 and 300 are provided on surface #2, surface #5, and surface #6, respectively (no low-E coatings are on surface #1, surface #3 and/or surface #4). By incorporating a double-sided coated lite 7 in the inboard position of the VIG unit 1, the desired thermal and solar performance improvement is achieved while reducing the potential for thermally-induced breakage and deflection to an acceptable level. It can be seen that for sample No. 7 in FIG. 5, the outboard glass substrate 3 was at 113 degrees F., the middle glass substrate 9 was at 119 degrees F., and the innermost glass substrate 7 was at 99 degrees F. Thus, the maximum difference in temperature between glass substrates of the VIG unit for Sample No. 7 was 20 degrees (119−99=20). It can be seen that for sample No. 8 in FIG. 5, the outboard glass substrate 3 was at 116 degrees F., the middle glass substrate 9 was at 115 degrees F., and the innermost glass substrate 7 was at 93 degrees F. Thus, the maximum difference in temperature between glass substrates of the VIG unit for Sample No. 8 was 22 degrees (115−93=22). Thus, it can be seen that the temperature of the middle glass substrate 9 was significantly lower for Sample Nos. 7-8, compared to Sample Nos. 3-6. And the difference in temperature between glass substrates 7, 9 for the VIG unit was significantly lower for Sample Nos. 7-8, compared to Sample Nos. 3-6. These unexpected and surprising results associated with example embodiments of this invention represent significant improvements in the art. Thus, example embodiments of this invention utilize low-E coatings 200 and 300 on both side of the innermost glass substrate 7 of the VIG unit, no low-E coatings on middle glass substrate 9, and one or more low-E coatings on substrate 3, which achieves the desired improvement in thermal and solar performance, while reducing the potential for thermally-induced breakage and deflection to an acceptable level.

FIG. 3 illustrates a window unit according to any example embodiment of this invention, which may be provided for example and without limitation in the frame(s) of FIG. 1 and/or FIG. 2, or in any other suitable frame. The window unit shown in FIG. 3, which reflects the window unit of Sample Nos. 7-8 from FIG. 5 discussed above, includes outboard glass substrate 3 and a VIG window unit 1. The VIG window unit 1 includes inboard glass substrate 7 and middle glass substrate which are separated from each other via spacers 24 so as to define low pressure gap 26 therebetween. An edge seal, discussed above, hermetically seals the edges of the glass substrates of the VIG unit to define low pressure gap 26. Low pressure gap between substrates 7 and 9 is preferably at a pressure less than atmospheric pressure, whereas the air gap 5 between substrates 9 and 3 may be at either atmospheric pressure or low pressure for instance. Gap 5 may be filled with gas (e.g., inert gas such as argon) in certain example embodiments. Outboard glass substrate 3 is configured to be located adjacent a building exterior, and inboard substrate 7 of the VIG unit is configured to be located adjacent the building interior, with respect to the building in which the window unit is mounted, or is to be mounted.

The window unit preferably has a visible transmission of at least 25%, more preferably of at least 35%, and most preferably of at least 45%. Glass substrates 3, 7 and 9 are each preferably from about 2-12 mm thick, more preferably from about 2-8 mm thick. Glass substrate 3 is preferably thicker than each of glass substrates 7 and 9 in certain example embodiments. For instance, glass substrate 3 is preferably from about 4-8 mm thick, more preferably from about 5-7 mm thick, whereas glass substrates 7 and 9 are preferably from about 3-5 mm thick (e.g., about 4 mm thick).

Still referring to FIG. 3 and Sample Nos. 7-8 of FIG. 5, first low-E coating 100 is provided on surface #2 of the window unit, and thus is on the interior major surface of outboard glass substrate 3 facing air gap 5. Meanwhile, second low-E coating 200 and third low-E coating 300 are provided on surface #s 5 and 6 of the window unit, which are both on inboard glass substrate 7 of the VIG unit. In particular, second low-E coating 200 is provided on the side of glass substrate 7 facing low pressure air gap 26, whereas third low-E coating 300 is provided on the side of glass substrate 7 facing the building interior. Thus, low-E coatings 200 and 300 are on opposite major surfaces of the inboard glass substrate 7 of the VIG unit.

The unexpected results associated with the provision of the low-E coatings in these locations are explained above in connection with FIG. 5.

FIG. 4 is a cross sectional view of an example low-E coating 200 and an example low-E coating 300, which may be provided on opposite major surfaces of inboard glass substrate 7 of the VIG window unit. As shown in FIG. 4, in certain example embodiments, low-E coating 300 on surface #6 of the window includes an IR reflecting layer 302 of or including a transparent conductive oxide such as indium-tin-oxide (ITO), and dielectric layers 301, 303, and 304. Dielectric layers 301 and 303 may be of or including silicon nitride and/or silicon oxynitride, and may be doped with Al, in certain example embodiments of this invention. Optional overcoat dielectric layer 304 may be of or including a metal oxide such as aluminium oxide, zirconium oxide (e.g., ZrO₂), and/or aluminium oxynitride, in various example embodiments of this invention. In certain example embodiments, layer 301 of or including silicon nitride (e.g., Si₃N₄) and/or silicon nitride may be from about 150-1200 angstroms thick, more preferably from about 200-800 angstroms thick, and most preferably from about 550-800 angstroms thick. In certain example embodiments, layer 303 of or including silicon nitride (e.g., Si₃N₄) and/or silicon nitride may be from about 150-1200 angstroms thick, more preferably from about 200-900 angstroms thick, and most preferably from about 550-850 angstroms thick. In certain example embodiments, IR reflecting layer of or including ITO may be from about 100-1800 angstroms thick, more preferably from about 400-1100 angstroms thick, and most preferably from about 500-700 angstroms thick. Low-E coating 300 preferably has a sheet resistance (Rₛ) of no greater than about 40 ohms/square, more preferably no greater than about 30 ohms/square, and most preferably having a sheet resistance of from about 15-40 ohms/square. In certain example embodiments, low-E coating 300 has a normal emissivity (Eₙ) no greater than about 0.45, more preferably no greater than about 0.40, even more preferably no greater than about 0.35. In certain example embodiments, low-E coating 300 has a normal emissivity (Eₙ) of from about 0.03 to 0.40, more preferably from about 0.20 to 0.40, and most preferably from about 0.25 to 0.35. Preferred low-E coatings 300 for location on surface #6 of the window unit are described, for example and without limitation, in U.S. Pat. Nos. 9,863,182, 9,199,875, 9,902,238, 9,776,915, 9,873,633, 9,816,316, 9,796,620, 6,936,347, 5,688,585, 5,557,462, 5,425,861, 4,413,877 and 3,682,528, the disclosures of which are all hereby incorporated herein by reference. In certain example embodiments, an ITO based low-E coating, such as low-E coating 300 shown in FIG. 4 and/or as described in any of U.S. Pat. Nos. 9,863,182, 9,199,875, 9,902,238, is preferred for coating 300 on surface #6 of the window unit because such coatings are well adapted to be exposed to ambient atmosphere, provide good solar characteristics, and are durable.

It is also possible for another low-E coating 300, such as that described above, to be provided on surface #1 of the window unit shown in FIGS. 1-3. However, in preferred embodiments of this invention, it is preferred that there is no low-E coating on either surface #3 or on surface #4 (i.e., no low-E coating on middle glass substrate 9), for thermal reasons discussed herein.

As shown in FIG. 4, in certain example embodiments, low-E coating 200 on surface #5 may include first and second IR reflecting layers 204, 210 of or including silver, separated by one or more dielectric layer(s).

Low-E coating 200 preferably has a sheet resistance (Rₛ) of no greater than about 20 ohms/square, more preferably no greater than about 10 ohms/square, and most preferably having a sheet resistance of from about 3-6 ohms/square. In certain example embodiments, low-E coating 200 has a normal emissivity (Eₙ) no greater than about 0.20, more preferably no greater than about 0.08, even more preferably no greater than about 0.06. In certain example embodiments, low-E coating 200 has a normal emissivity (Eₙ) of from about 0.02 to 0.06, more preferably from about 0.035 to 0.06. Preferred low-E coatings 200 for location on surface #5 of the window unit are described, for example and without limitation, in U.S. Pat. Nos. 9,873,633, 9,816,316, 9,796,620, 6,936,347, 5,688,585, 5,557,462, 5,425,861, 4,413,877 and 3,682,528, the disclosures of which are all hereby incorporated herein by reference.

Thus, in certain example embodiments, low-E coating 200 is configured to have a significantly lower sheet resistance, and a significantly lower normal emissivity, than low-E coating 300. For example, low-E coating 200 is configured to have a sheet resistance (Rₛ) at least 5 ohms/square lower, more preferably at least 10 ohms/square lower, than that of low-E coating 300. As another example, low-E coating 200 is configured to have a normal emissivity at least 0.05 lower, more preferably at least 0.10 lower, than that of low-E coating 300. This design is advantageous in that it permits coating 200 to reflect more IR radiation than coating 300, yet it allows coating 300 to be more durable and practical for exposure to ambient atmosphere in the building interior. Moreover, in certain example embodiments, low-E coating 200 has a high enough sheet resistance and/or emissivity so as to not allow middle glass sheet 9 to become too hot during normal operation conditions.

Referring to FIG. 4, an example low-E coating 200 on inboard glass substrate 7 is illustrated. IR reflecting layers 204, 210 are of or including silver, gold, or the like, upper contact layers 205, 211 are of or including a material such as NiCr, NiCrOₓ, NiCrNₓ, NiCrMoOₓ, NiCrMo, or NiTiNbOₓ, transparent dielectric layers 203, 209 are of or including zinc oxide or the like which may be doped with from 1-10% Al (atomic %) and which may optionally include tin, transparent dielectric layers 201, 207, 213 are of or including silicon nitride and/or silicon oxynitride of any suitable stoichiometry (e.g., Si₃N₄) which may be doped with Al or the like, dielectric layer 202 is of or including titanium oxide or other suitable material, dielectric layer 206 is of or including zinc stannate, and transparent dielectric layers 208, 212 are of or including tin oxide (e.g., SnO₂). Other layers and/or materials may also be provided in the coating in certain example embodiments of this invention, and it is also possible that certain layers of coating 200 may be removed or split in certain example instances. For example, layer 202 of coating 200 may be removed, and silicon nitride based layer 201 may be split with an absorber layer (e.g., NiCr) in certain example embodiments. Moreover, one or more of the layers discussed above may be doped with other materials in certain example embodiments of this invention. This invention is not limited to the layer stacks shown in FIG. 4, as the FIG. 4 stacks are provided for purposes of example. While the layer system or coating is “on” or “supported by” substrate 7 (directly or indirectly), other layer(s) may be provided therebetween. Thus, for example, the coating 200 of FIG. 4 may be considered “on” and “supported by” the substrate 7 even if other layer(s) are provided between layer 201 and substrate 7. Moreover, certain layers of the illustrated coating may be removed in certain embodiments, while others may be added between the various layers or the various layer(s) may be split with other layer(s) added between the split sections in other embodiments of this invention without departing from the overall spirit of certain embodiments of this invention. Other example low-E coatings that may be used for coating 200 on surface #5 of the window unit are described, for example and without limitation, in U.S. Pat. Nos. 9,873,633, 9,816,316, 9,796,620, 6,936,347, 5,688,585, 5,557,462, 5,425,861, 4,413,877 and 3,682,528, the disclosures of which are all hereby incorporated herein by reference.

Low-E coating 100 may be the same as, or different than, low-E coating 200 in certain example embodiments of this invention. Thus, the silver-based low-E coating 200 shown in FIG. 4, for example, may be used for coating 100 on surface #2 of the window in certain example embodiments. Other example low-E coatings that may be used for coating 100 on surface #2 of the window unit are described, for example and without limitation, in U.S. Pat. Nos. 9,873,633, 9,816,316, 9,796,620, 6,936,347, 5,688,585, 5,557,462, 5,425,861, 4,413,877 and 3,682,528, the disclosures of which are all hereby incorporated herein by reference. In preferred embodiments, coating 200 has a higher emissivity and sheet resistance than does coating 100, for instance the sheet resistance of coating 200 is at least 1 ohms/square greater than that of coating 100, more preferably at least 2 ohms/square greeater.

In an example embodiment of this invention, there is provided a window unit comprising: a first glass substrate 3 configured to be located at an exterior side of the window unit to face a building exterior; a vacuum insulating glass (IG) window unit 1 comprising second 9 and third 7 glass substrates spaced apart from each other via at least a plurality of spacers 24, and having a low pressure space 26 between the second and third glass substrates 9 and 7 at pressure less than atmospheric pressure, wherein the third glass substrate 7 is configured to be located at an interior side of the window unit to face a building interior, and the second glass substrate 9 is a middle glass substrate located between at least the first 3 and third 7 glass substrates; an air gap 5 provided between the first glass substrate 3 and the second glass substrate 9; a first low emissivity (low-E) coating 100 comprising at least one infrared (IR) reflecting layer located between at least a pair of dielectric layers, wherein the first low-E coating 100 is located on a major surface of the first glass substrate 3 facing the air gap 5; a second low-E coating 200 comprising at least one IR reflecting layer 204 and/or 210 located between at least a pair of dielectric layers, wherein the second low-E coating 200 is located on a first major surface of the third glass substrate 7 facing the low pressure space 26; a third low-E coating 300 comprising at least one IR reflecting layer 302 located between at least a pair of dielectric layers, wherein the third low-E coating 300 is located on a second major surface of the third glass substrate 7 and is configured to face a building interior, so that the third glass substrate 7 is located between the second and third low-E coatings 200 and 300; and wherein no low-E coating is provided on the second glass substrate 9.

In the window unit of the immediately preceding paragraph, the at least one IR reflecting layer of the first low-E coating may comprise silver, and/or the at least one IR reflecting layer of the second low-E coating may comprise silver.

In the window unit of any of the preceding two paragraphs, the IR reflecting layer of the third low-E coating may comprise a transparent conductive oxide such as indium-tin-oxide (ITO).

In the window unit of any of the preceding three paragraphs, there may be at least one hermetic edge seal located between, and sealing the low pressure space between, the second and third glass substrates of the VIG unit.

In the window unit of any of the preceding four paragraphs, the air gap between the first and second substrates may comprise an inert gas (e.g., argon).

In the window unit of any of the preceding five paragraphs, the first low-E coating may have a sheet resistance (Rₛ) of no greater than about 20 ohms/square, more preferably of no greater than about 10 ohms/square.

In the window unit of any of the preceding six paragraphs, the second low-E coating may have a sheet resistance (Rₛ) of no greater than about 20 ohms/square, more preferably of no greater than about 10 ohms/square.

In the window unit of any of the preceding seven paragraphs, each of the first and second low-E coatings may have a normal emissivity (Eₙ) no greater than about 0.20, more preferably no greater than about 0.06.

In the window unit of any of the preceding eight paragraphs, the third low-E coating may have a sheet resistance (Rₛ) of no greater than about 40 ohms/square and/or a normal emissivity (Eₙ) no greater than about 0.45.

In the window unit of any of the preceding nine paragraphs, the second low-E coating may have a sheet resistance (Rₛ) at least 5 ohms/square lower (more preferably at least 10 ohms/square lower) than the sheet resistance of the third low-E coating.

In the window unit of any of the preceding ten paragraphs, the first low-E coating may have a sheet resistance (Rₛ) at least 5 ohms/square lower (more preferably at least 10 ohms/square lower) than the sheet resistance of the third low-E coating.

In the window unit of any of the preceding eleven paragraphs, the second low-E coating may have a normal emissivity (Eₙ) at least 0.05 lower than that of the third low-E coating.

In the window unit of any of the preceding twelve paragraphs, the pair of dielectric layers of the third low-E coating may each comprise silicon nitride and/or silicon oxynitride, and/or the IR reflecting layer of the third low-E coating may comprise ITO and be located between and directly contacting the pair of dielectric layers.

In the window unit of any of the preceding thirteen paragraphs, the window unit may have a visible transmission of at least 25%, more preferably of at least 35%, and most preferably of at least 45%.

In the window unit of any of the preceding fourteen paragraphs, a sheet resistance of the second low-E coating may be at least 1 ohms/square greater (more preferably at least 2 ohms/square greater, and even more preferably at least 3 ohms/square greater) than a sheet resistance of the first low-E coating, in order to reduce the likelihood of breakage.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A window unit comprising:
a first glass substrate configured to be located at an exterior side of the window unit to face a building exterior;
a vacuum insulating glass (IG) window unit comprising second and third glass substrates spaced apart from each other via at least a plurality of spacers, and having a low pressure space between the second and third glass substrates at pressure less than atmospheric pressure, wherein the third glass substrate is configured to be located at an interior side of the window unit to face a building interior, and the second glass substrate is a middle glass substrate located between at least the first and third glass substrates;
an air gap provided between the first glass substrate and the second glass substrate;
a first low emissivity (low-E) coating comprising at least one infrared (IR) reflecting layer located between at least a pair of dielectric layers, wherein the first low-E coating is located on a major surface of the first glass substrate facing the air gap;
a second low-E coating comprising at least one IR reflecting layer located between at least a pair of dielectric layers, wherein the second low-E coating is located on a first major surface of the third glass substrate facing the low pressure space;
a third low-E coating comprising at least one IR reflecting layer located between at least a pair of dielectric layers, wherein the third low-E coating is located on a second major surface of the third glass substrate and is configured to face a building interior, so that the third glass substrate is located between the second and third low-E coatings; and
wherein no low-E coating is provided on the second glass substrate.

2. The window unit of claim 1, wherein the at least one IR reflecting layer of the first low-E coating comprises silver, the at least one IR reflecting layer of the second low-E coating comprising silver, and the at least one IR reflecting layer of the third low-E coating comprises a transparent conductive oxide.

3. The window unit of claim 2, wherein the transparent conductive oxide comprises indium-tin-oxide (ITO).

4. The window unit of claim 1, further comprising at least one hermetic edge seal located between, and sealing the low pressure space between, the second and third glass substrates.

5. The window unit of claim 1, wherein the air gap between the first and second substrates comprises an inert gas.

6. The window unit of claim 1, wherein the first low-E coating has a sheet resistance (Rₛ) of no greater than about 20 ohms/square.

7. The window unit of claim 1, wherein the first low-E coating has a sheet resistance (Rₛ) of no greater than about 10 ohms/square.

8. The window unit of claim 1, wherein the second low-E coating has a sheet resistance (Rₛ) of no greater than about 20 ohms/square.

9. The window unit of claim 1, wherein the second low-E coating has a sheet resistance (Rₛ) of no greater than about 10 ohms/square.

10. The window unit of claim 1, wherein each of the first and second low-E coatings has a normal emissivity (Eₙ) no greater than about 0.20.

11. The window unit of claim 1, wherein each of the first and second low-E coatings has a normal emissivity (Eₙ) no greater than about 0.06.

12. The window unit of claim 1, wherein the third low-E coating has a sheet resistance (Rₛ) of no greater than about 40 ohms/square and/or a normal emissivity (Eₙ) no greater than about 0.45.

13. The window unit of claim 1, wherein the second low-E coating has a sheet resistance (Rₛ) at least 5 ohms/square lower than the sheet resistance of the third low-E coating.

14. The window unit of claim 1, wherein the second low-E coating has a sheet resistance (Rₛ) at least 10 ohms/square lower than the sheet resistance of the third low-E coating.

15. The window unit of claim 1, wherein the first low-E coating has a sheet resistance (Rₛ) at least 5 ohms/square lower than the sheet resistance of the third low-E coating.

16. The window unit of claim 1, wherein the first low-E coating has a sheet resistance (Rₛ) at least 10 ohms/square lower than the sheet resistance of the third low-E coating.

17. The window unit of claim 1, wherein the second low-E coating has a normal emissivity (Eₙ) at least 0.05 lower than that of the third low-E coating.

18. The window unit of claim 1, wherein the pair of dielectric layers of the third low-E coating each comprise silicon nitride and/or silicon oxynitride, and wherein the IR reflecting layer of the third low-E coating comprises ITO and is located between and directly contacting the pair of dielectric layers.

19. The window unit of claim 1, wherein the window unit has a visible transmission of at least 25%.

20. The window unit of claim 1, wherein the window unit has a visible transmission of at least 45%.

21. The window unit of claim 1, wherein a sheet resistance of the second low-E coating is at least 1 ohms/square greater than a sheet resistance of the first low-E coating.

22. The window unit of claim 1, wherein a sheet resistance of the second low-E coating is at least 2 ohms/square greater than a sheet resistance of the first low-E coating.
